(19) United States
(12) Patent Application Publication
(10) Pub. No.: US 2006/0191095 A1
(43) Pub. Date: Aug. 31, 2006

(54) Composite buckling spring in compression spring wiper arm

(75) Inventor: H. Charles Buchanan JR., Dayton, OH (US)

Correspondence Address: YOUNG & BASILE, P.C., 3001 WEST BIG BEAVER ROAD, SUITE 624, TROY, MI, 48084, US

(73) Assignee: Valeo Electrical Systems, Inc., Auburn Hills, MI (US)

(21) Appl. No.: 11/068,414

(22) Filed: Feb. 28, 2005

(51) Int. Cl. B60S 1/34

(52) U.S. Cl. 15/250.352; 15/250.351; 29/428; 29/896.9

(57) ABSTRACT

A windshield wiper arm assembly for wiping a windshield of a motor vehicle can include a wiper linkage head having a bore formed therein for being connected to a rotatable wiper drive shaft. A wiper arm can be coupled to the wiper linkage head through a pivot pin allowing pivoting movement of the wiper arm with respect to the wiper linkage head between a stable windshield engaged position and a stable windshield disengage position. A beam compression spring can bias the wiper arm with respect to the wiper linkage head between the stable windshield engaged position and the stable windshield disengage position. A process for fabricating a beam compression spring for a windshield wiper arm can include the steps of cross-weaving an elongate tri-axial glass fiber sock, bathing the elongate glass woven sock in a thermoset resin, and curing the bathed cross-woven sock in a heated pultrusion die to form a pultruded elongate strip. Opposite side edges of the pultruded elongate strip can be overmolded with thermoplastic extruded cylindrical bearing ends. The elongate strip can be cut transversely to form a pultruded beam compression spring of a desired width having overmolded cylindrical bearing ends and cross-woven glass fibers oriented axially between the bearing ends at an angle of between approximately 0° and approximately 30°, inclusive.

### FIELD OF THE INVENTION

The present invention relates to a composite buckling spring for use in a compression spring wiper arm assembly.

### BACKGROUND

Over center compression spring wiper arms, where the spring contacts the head casting above the pivot, require a compression spring approximately thirteen millimeters (13 mm) in diameter with clearances of one millimeter (1 mm) to two millimeter (2 mm), and the spring being approximately forty millimeters to fifty millimeters (40 mm-50 mm) long plus extra length for a stiffening rod to keep the spring in place. It would be desirable to provide a compression spring with a very constant generated force.

U.S. Pat. No. 4,991,251 illustrates a wiper arm having a service up feature for the windshield wiper of an automotive vehicle. The service up feature is a European automotive requirement. Typically, an over center tension spring, such as that illustrated in U.S. Pat. No. 4,947,508 allows the wiper arm to be pivoted about the head which is fixed to the vehicle, away from the windshield to a locked, over center spring position to fix the wiper arm and attached blade in a position spaced from the windshield. Various automotive manufactures use a compression spring for the service up feature on automotive windshield wipers. There are numerous problems with the use of a compression spring, such as a wide range of spring constant variability from spring to spring as well as the loss of spring force over time. The compression spring also functions to maintain the outer end of the wiper blade against the windshield with appropriate wiping force as the wiper blade moves across the generally curved windshield.

A composite pultruded plastic fiber linkage has been proposed in U.S. Pat. No. 6,148,470. The advantage of a composite pultruded plastic fiber linkage is that it provides a repeatable spring force which does not deteriorate over time. The pultruded linkage of U.S. Pat. No. 6,148,470 is also less expensive than corresponding metal linkages.

### SUMMARY

The present invention eliminates the over center service up spring end clip by using a beam placed in compression. The beam can be a separate composite pultruded member, or alternatively the beam can be integrally stamped from a steel wiper arm. In either case, a beam compression spring is formed in association with the wiper arm to provide a service up position and can be biased between the wiper arm and the wiper linkage head. The beam and the wiper arm can be formed of steel material or a composite pultruded material. The beam can be a loose piece attached to the arm or integrally formed with the arm In either case, the beam defines a spring force biased against the wiper head and wiper arm

The present invention can use a flat composite pultrusion, thin, wide as permitted in the arm construction, and approximately sixty millimeters (60 mm) to approximately 100 millimeters (100 mm) long. The compression spring beam is placed in compression in a buckled situation. The force generated can be very constant and a pivot point between the wiper arm and wiper linkage head can be placed to operate at a fairly constant offset for the rise and fall projection of the arm through active use. The pultruded compression spring beam has the ability to deflect substantially without fracture. A thin, axially oriented, or nearly axially oriented, spring is pultruded with 21% thermoset polyester, or similar thermoset or thermoplastic resin with glass fibers oriented within 15° of axial, ±20°. These strips can be cut to the required design length to buckle per a Euler formula P_{cr}=(π²×EI)/L². A tab or other protrusion can be used to insure single direction buckling of the beam compression spring. Opposing sockets can be positioned so as to give a working range load, by way of example and not limitation ±10° of perpendicular to an axis of a load, a very constant moment. This configuration can provide a tip load of ±1½% in ±10° arm motion and ±6% in ±20° travel. It should be recognized that the design can be altered to vary the loads outside the close intolerance ranges provided, by way of example and not limitation, the present invention can be configured to keep compressive stresses below approximately 60,000 lbs per square inch (psi) for high cycles and near or under 100,000 lbs per square inch (psi) for low cycle operation. It should be noted that the load drops to zero rapidly once the beam compression spring becomes unbuckled which can be advantages for assembly or a no-load “park” position. By way of example and not limitation, compressive load of a pultruded axially oriented glass E-glass 113 yield 75% by weight, 21% thermoset polyester by weight, 4% fill by weight, 25 millimeter wide, 60 millimeter long, 1.25 millimeter thick σ=51 ksi at 2 millimeters, 98 ksi at 8 millimeter service up position.

A method of weaving and fabricating arm springs according to the present invention can include a tri-axial woven sock made or purchased. The tri-axial woven sock can be run through a thermoset resin bath and cured in a heated pultrusion die. The cured product can then be fed into an extruder to add cylindrical ends to the strip in order to provide a continuous strip that can be cut off in varying widths. The varying widths can provide varying compressive load depending on the width. The weaving of the tri-axially sock provides nearly cross axis perpendicularity, later after being cut off, and leaves the fibers nearly axial to the buckling load to optimize stress and strain characteristics of the pultruded beam compression spring according to the present invention.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified cross sectional detail of a wiper arm and wiper linkage head according to the present invention;

FIG. 2 is a detailed perspective view of a beam compression spring according to the present invention;

FIG. 3 is a graph illustrating force in Newton versus deflection for a beam compression spring according to the present invention; and

FIG. 4 is a simplified schematic view of a weaving and fabrication method for producing beam compression springs according to the present invention.

### DETAILED DESCRIPTION

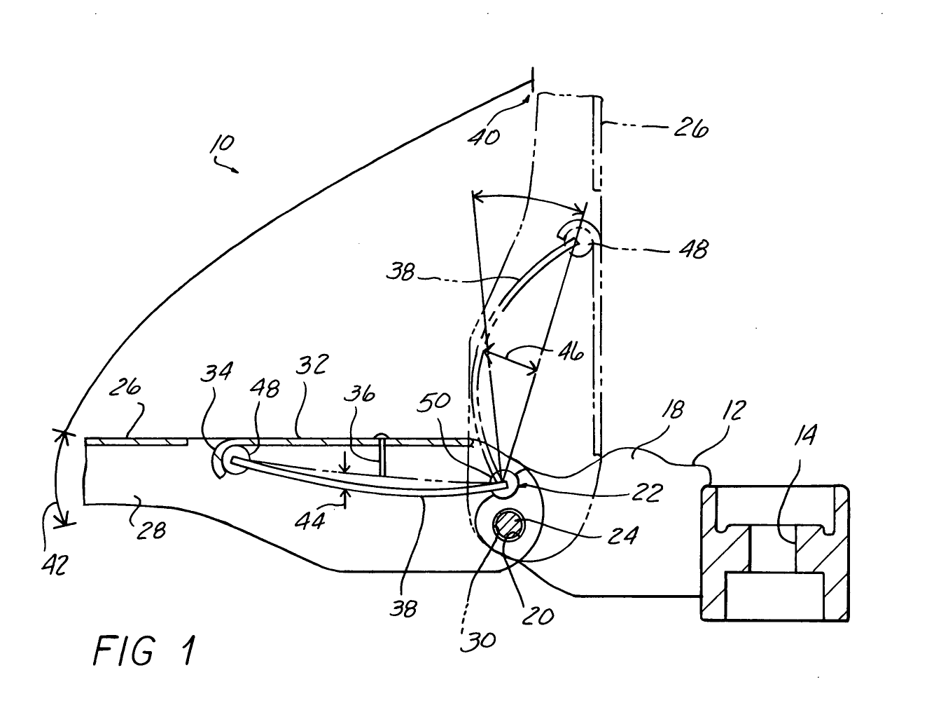

Referring now to FIG. 1, a wiper arm assembly 10 can be provided for wiping a windshield of a motor vehicle. A wiper linkage head 12 can include a bore 14 formed therein for being connected to a rotatable wiper drive shaft (not shown). The wiper linkage head 12 can be formed by any suitable process, by way of example and not limitation, such as casting or stamping. The wiper linkage head 12 includes two spaced sidewalls 18 extending outwardly from the portion including the bore 14. The two spaced sidewalls 18 can include a pivot aperture 20 extending inwardly toward one another, or extending through an entire distance between the two spaced sidewalls 18. The pivot aperture 20 can be formed integrally with the wiper linkage head 12, or can be formed after casting or stamping the wiper linkage head 12. The wiper linkage head 12 can also include a socket recess 22 extending inwardly from each of the two spaced sidewalls 18 toward one another, or can extend across the entire distance between the two spaced sidewalls 18. The socket recess 22 can be formed integrally with the wiper linkage head 12, or can be formed after casting or stamping the wiper linkage head 12.

As best seen in FIG. 1, the wiper linkage head 12 is pivotally attached by pivot pin 24 passing through pivot aperture 20 to a wiper arm 26. The wiper arm 26 can include two spaced sidewalls 28 having pivot apertures 30 formed in coaxial alignment with the pivot aperture 20 through the linkage head 12 allowing passage of the pivot pin 24 therethrough. The two spaced sidewalls 28 can be interconnected by a web 32 defining a U-shaped cross-section. The wiper arm 26 can be connected to a wiper blade (not shown in the drawing). The wiper arm 26 is pivotally connected to the linkage head 12 in order to allow the wiper arm to move within a normal rise and fall about the pivot axis during normal wiping action. In addition, the wiper arm 26 can be tipped up about the pivot axis to a service up position extending generally perpendicular to the linkage head 12. The wiper arm 26 can include a socket recess 34 spaced from the socket recess 22 formed in the linkage head 12. The two socket recesses 22, 34 generally facing one another in an opposing relationship. Generally midway between the opposing recesses 22, 34, the wiper arm 26 can include a tab or other protrusion 36. The tab or protrusion 36 can operably engage the beam compression spring 38 to insure deflection in a desired direction. The initial deflection of the beam compression spring 38 can provide a tip load within ±10% rise and fall about the pivot point during the normal wiping action within 1½% of design load. The wiper arm 26 can pivot from the normal wiping action position to a service up position passing through an over center position with respect to the two opposing socket recesses 22, 34. The wiper arm 26 is shown in phantom line in the service up position 40. The wiper arm 26 is shown in solid line at the normal wiping action position 42.

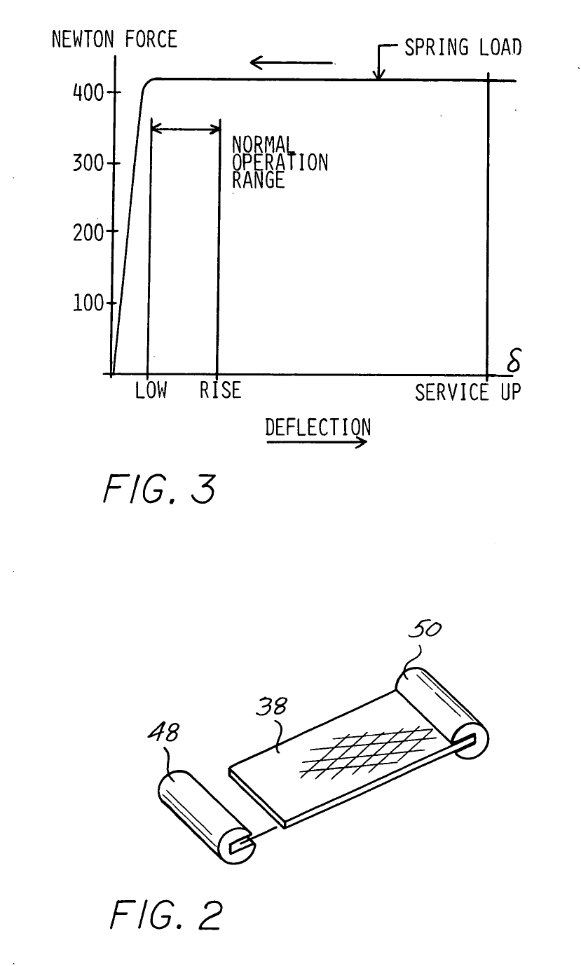

Referring now to FIGS. 1 and 2, the beam compression spring 38 can be formed of a composite material with outer 48, 50 ends of complementary shape to be received within the two spaced recesses 22, 34. The longitudinal length of the beam compression spring being greater than the distance between the two facing, opposing socket recesses 22, 34 causes the beam compression spring to bend or flex into an initial deflection position 44. Deflection in the opposite direction can be prevented by appropriate placement of the tab or other protrusion 36. When moved into the service up position 40, the composite beam compression spring 38 is in a buckling mode or position 46 in order to retain the wiper arm 26 in a stable service up position 40. When in the service up position 40, the socket recess 34 has passed over center with respect to the socket recess 22 in order to provide a stable orientation of the wiper arm 26 with respect to the linkage head 12. When in the normal wiping action position 42, the initial deflection position 44 of the composite compressive spring 38 provides sufficient tip load on the wiper blade (not shown) in order to contact the windshield during the normal rise and fall of the windshield wiper during the normal wiping action across the entire oscillatory sweeping motion of the wiper arm

The beam compression spring 38 can be formed of any suitable material using any known manufacturing process. By way of example and not limitation, the beam compression spring 38 can be formed of steel, either separately, or as a stamping with either the wiper arm 26 or linkage head 12, or the beam compression spring 38 can be formed of a composite material, either separately, or as part of either the wiper arm 26 or linkage head 12.

Referring now to FIG. 3, the deflection force in Newton is shown versus the deflection of the wiper arm 26. As can be seen, the force increases rapidly to a constant spring load provided over the normal operating wiping range between low and high pivoted positions of the wiper arm 26. The spring load remains constant through the service up deflection position.

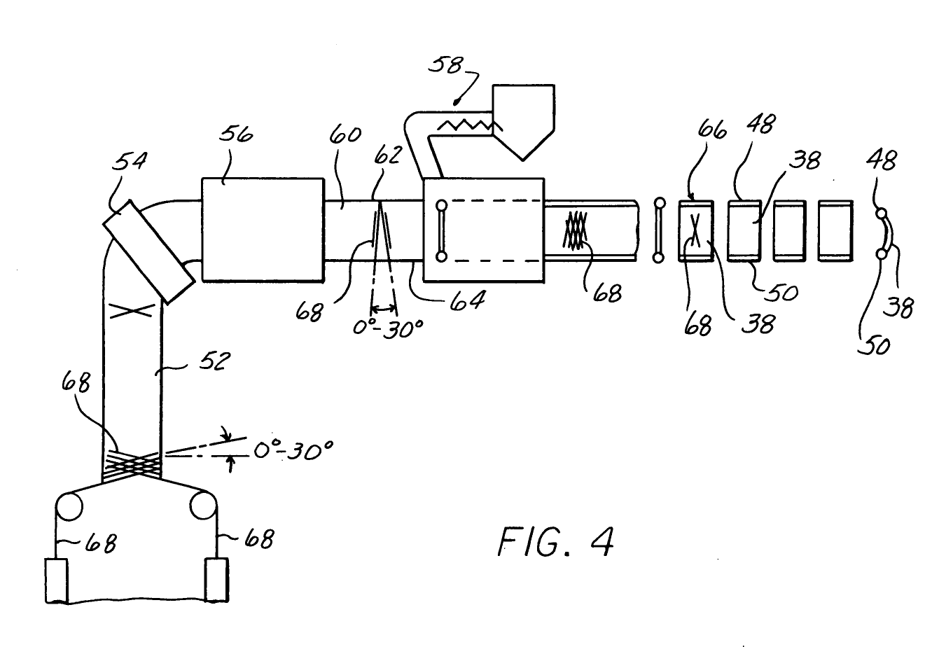

Referring now to FIG. 4, a process for manufacturing a beam compression spring 38 according to the present invention can include the steps of weaving a tri-axial sock. 52 The sock can be run through a thermoset resin bath 54 and cured in a heated pultrusion die 56. The sock 52 can then be fed into an extruder 58 to add cylindrical ends 48, 50 to the strip 60 along opposite longitudinally extending side edges 62,64 to provide a continuous strip 60 that can be cut off in varying widths. The varying widths of the cut off strips 66 provide bearing compressive load depending on the width. The weaving of the sock 52 provides nearly cross axis perpendicularity that, later after cutoff, leaves the fibers 68 nearly axial to the buckling load to optimize stress and strain characteristics on the composite beam compression spring 38 according to the present invention.

In the windshield wiper arm assembly 10 according to the present invention, the wiper arm 26 can be coupled to the wiper linkage head 12 through a pivot pin 24 allowing pivoting movement of the wiper arm 26 with respect to the wiper linkage head 12 between a stable windshield engaging position 42 and a stable windshield disengaged position 40. The beam compression spring 38 can bias the wiper arm 26 and the wiper linkage head 12 between the stable windshield engaging position 42 and the stable windshield disengage position 40. The beam compression spring 38 can be integrally formed with one of the wiper arm 26 and the wiper linkage head 12. Alternatively, the beam compression spring can be attachable between the wiper arm 26 and the linkage head 12. The beam compression spring 38 can be formed of a composite pultruded material or can be integrally stamped from a metal material. The beam compression spring 38 can include a cross-woven elongate tri-axial glass fiber sock 52 bathed in a thermoset resin bath 54 and cured in a heated pultrusion die 56 to form a pultruded elongate strip 60. The pultruded elongate strip 60 can be overmolded with thermoplastic extruded cylindrical bearing ends 48, 50 on opposite sides 62, 64. The elongate strip 60 can be cut transversely to form a pultruded beam compression spring 38 of a desired width having overmolded cylindrical bearing ends 48, 50 and cross-woven glass fibers 68 oriented axially between the bearing ends 48, 50 at an angle between approximately 0° and approximately 30°, inclusive.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A windshield wiper arm assembly for wiping a windshield of a motor vehicle comprising:
a wiper linkage head having a bore formed therein for being connected to a rotatable wiper-drive shaft;
a wiper arm coupled to the wiper linkage head through a pivot pin allowing pivoting movement of the wiper arm with respect to the wiper linkage head between a stable windshield-engaged position and a stable windshield-disengaged position; and
a beam compression spring for biasing the wiper arm and the wiper linkage head between the stable windshield-engaged position and the stable windshield-disengaged position.

2. The assembly of claim 1 further comprising:
the beam compression spring integrally formed with one of the wiper arm and the wiper linkage head.

3. The assembly of claim 1 further comprising:
the beam compression spring integrally formed with the wiper arm.

4. The assembly of claim 1 further comprising:
the beam compression spring attachable to the wiper arm.

5. The assembly of claim 1 further comprising:
the beam compression spring formed of a composite pultruded material.

6. The assembly of claim I further comprising:
the beam compression spring integrally stamped from a metal material forming the wiper arm.

7. The assembly of claim 1 further comprising:
the beam compression spring for a windshield wiper including a cross-woven elongate tri-axial glass fiber sock bathed in a thermoset resin and cured in a heated pultrusion die to form a pultruded elongate strip.

8. The assembly of claim 7 further comprising:
the pultruded elongate strip overmolded with thermoplastic extruded cylindrical bearing ends on opposite sides.

9. The assembly of claim 7 further comprising:
the elongate strip cut transversely to form a pultruded beam compression spring of a desired width having overmolded cylindrical bearing ends and cross-woven glass fibers oriented axially between the bearing ends at an angle of between approximately 0° and approximately 30°, inclusive.

10. A process for assembling a windshield wiper arm for wiping a windshield of a motor vehicle comprising the steps of:
forming a wiper linkage head having a bore for being connected to a rotatable wiper-drive shaft;
coupling a wiper arm to the wiper linkage head through a pivot pin allowing pivoting movement of the wiper arm with respect to the wiper linkage head between a stable windshield-engaged position and a stable windshield-disengaged position; and
biasing the wiper arm and the wiper linkage head with a beam compression spring between the stable windshield-engaged position and the stable windshield-disengaged position.

11. The process of claim 10 further comprising the step of:
integrally forming the beam compression spring with one of the wiper arm and the wiper linkage head.

12. The process of claim 10 further comprising the step of:
integrally forming the beam compression spring with the wiper arm.

13. The process of claim 10 further comprising the step of:
attaching the beam compression spring to the wiper arm.

14. The process of claim 10 further comprising the step of:
forming the beam compression spring of a composite pultruded material.

15. The process of claim 10 further comprising the step of:
integrally stamping the beam compression spring from a metal material forming the wiper arm.

16. The process of claim 10, wherein the beam compression spring further comprising the steps of:
cross-weaving an elongate tri-axial glass fiber sock;
bathing the elongate cross-woven sock in a thermoset resin; and
curing the bathed cross-woven sock in a heated pultrusion die to form a pultruded elongate strip.

17. The process of claim 16 further comprising the step of:
overmolding thermoplastic extruded cylindrical bearing ends on opposite sides of the pultruded elongate strip.

18. The process of claim 16 further comprising the step of:
cutting the elongate strip transversely to form a pultruded beam compression spring of a desired width having overmolded cylindrical bearing ends and cross-woven glass fibers oriented axially between the bearing ends at an angle of between approximately 0° and approximately 30°, inclusive.

19. A process for fabricating a beam compression spring for a windshield wiper arm assembly comprising the steps of
cross-weaving an elongate tri-axial glass fiber sock;
bathing the elongate cross-woven sock in a thermoset resin; and
curing the bathed cross-woven sock in a heated pultrusion die to form a pultruded elongate strip.

20. The process of claim 19 further comprising the step of
overmolding thermoplastic extruded cylindrical bearing ends on opposite sides of the pultruded elongate strip.

21. The process of claim 20 further comprising the step of:
cutting the elongate strip transversely to form a pultruded beam compression spring of a desired width having overmolded cylindrical bearing ends and cross-woven glass fibers oriented axially between the bearing ends at an angle of between approximately 0° and approximately 30°, inclusive.
